(19) United States
(12) Patent Application Publication
(10) Pub. No.: US 2007/0076544 A1
(43) Pub. Date: Apr. 5, 2007

(54) OPTICAL DISC, OPTICAL DISC APPARATUS, AND MANUFACTURING METHOD OF THE OPTICAL DISC

(76) Inventors: Toshihiro Sugaya, Moriya-shi (JP); Masato Otsuka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/533,183

(22) Filed: Sep. 19, 2006

(30) Foreign Application Priority Data
Sep. 30, 2005 (JP) 2005-288158

(51) Int. Cl. G11B 7/00; G11B 3/70

(52) U.S. Cl. 369/44.27; 369/283

(57) ABSTRACT

One embodiment of the present invention is based on the following (1) An optical disc has a triple layer structure in which there are a light transmission layer, a first recording layer which is accessed with a first laser beam, and a second recording layer and a third recording layer which are accessed with a second laser beam. (2) The distance of the light transmission layer from a light incidence plane to the first recording layer is a minimum of 550 μm. (3) The distance between the first recording layer and the third recording layer is a maximum of 72 μm. (4) The distance between the second recording layer and the third recording layer is a minimum of 19 μm. (5) The distance between the first recording layer and the second recording layer is about 28 to 38 μm.

### CROSS-REFERENCE TO RELATED APPLICATIONS

This application is based upon and claims the benefit of priority from Japanese Patent Application No. 2005-288158, filed Sep. 30, 2005, the entire contents of which are incorporated herein by reference.

### BACKGROUND

1. Field

One embodiment of the invention relates to an optical disc, an optical disc apparatus and a manufacturing method of the optical disc. It is suitably applied to an optical disc such as a DVD which serves as a medium to store digitized video and audio works such as movies and music. It is further applied to an optical disc apparatus which reads information recorded on the optical disc, and digital work publication using the optical disc as a recording medium.

2. Description of the Related Art

<Outline of the DVD Standard>

One known type of optical disc for storing digital images is the Digital Versatile Disc (DVD), which is widely used all over the world mainly for storing and delivering movie content (digital work publications). DVD is a format created by the DVD forum, which is open to the public as DVD Book (refer to the World Wide Web: dvdforum.org). The DVD has also been determined in international standards and JIS. Here, the international standard ISO/IEC 16448 for 120 mm DVD-ROM, one of the DVD physical formats, will be briefly explained. Moreover, there is ECMA-267 as a document associated with the international standards.

There are four types of 120 mm DVD-ROM: single-sided single layer, single-sided dual layer, double-sided single layer, and double-sided dual layer. In delivery of an accumulation of content of movies and the like, two types of single-sided discs are mainly used: one is a single-sided single layer DVD disc (4.7 GB) and the other is a single-sided dual layer DVD disc (8.54 GB).

On the other hand, the development of a disc whose capacity is larger than that of the aforementioned DVD (referred to as the existing DVD) has been desired. This comes from a desire to store High Definition (HD) images on a single disc (temporarily referred to as a next-generation DVD).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing the relationship between the basic structure of a single-sided single layer DVD disc and an optical head;

FIGS. 2A and 2B are exemplary diagrams showing the position of the recording layer of the single-sided single layer DVD disc;

FIG. 3 is an exemplary diagram showing the relationship between the basic structure of a single-sided dual layer HD DVD disc and an optical head;

FIG. 4 is an exemplary diagram showing the position of the recording layers of the single-sided dual layer HD DVD disc;

FIG. 5 is an exemplary diagram showing the relationship between the basic structure of an HD DVD/DVD Twin format disc and an optical head;

FIG. 6 is an exemplary diagram showing the position of the recording layers in the HD DVD/DVD Twin format disc;

FIG. 7 is an exemplary diagram showing the relationship between the basic structure of an optical disc and an optical head;

FIG. 8 is an exemplary diagram showing one example of how to design the thickness of substrates and space layer thickness of the optical disc;

FIG. 9 is an exemplary diagram showing an example of a disc manufacturing process;

FIG. 10 is an exemplary diagram showing the reflectivities of layers of the optical disc with respect to a red laser beam;

FIG. 11 is an exemplary diagram showing the reflectivities of the layers of the optical disc with respect to a blue-violet laser beam;

FIGS. 12A and 12B are exemplary diagrams showing calculated values of the reflectivity and transmissivity of an alloy film;

FIG. 13 is an exemplary diagram showing the reflectivities (a case where birefringence is not included) of the layers of the optical disc with respect to a red laser beam and a blue-violet laser beam;

FIG. 14 is an exemplary diagram showing the reflectivities (a case where birefringence is included) of the layers of the optical disc with respect to a red laser beam and a blue-violet laser beam;

FIG. 15 is an exemplary diagram showing the configuration of a player complying with the DVD standard;

FIG. 16 is an exemplary diagram showing an operation flow when the optical disc of the present invention is played back with a red laser beam on the player complying with the DVD standard;

FIG. 17 is an exemplary diagram showing the relationship between focus signals and a focus servo when the optical disc of the present invention is played back with a red laser beam on the player complying with the DVD standard;

FIG. 18 is an exemplary diagram showing the configuration of an HD DVD player compatible with the optical disc;

FIG. 19 is an exemplary diagram showing an operation flow when the optical disc of the present invention is played back on the HD DVD player compatible with the optical disc;

FIG. 20 is an exemplary diagram showing the relationship between focus signals and a focus servo when the optical disc of the present invention is played back with a blue-violet laser beam on the HD DVD player compatible with the optical disc;

FIG. 21 is an exemplary diagram showing the configuration of an HD DVD/DVD compatible player compatible with the optical disc; and

FIG. 22 is an exemplary diagram showing an operation flow of the DVD/DVD compatible player compatible with the optical disc.

### DETAILED DESCRIPTION

Various embodiments according to the invention will be described hereinafter with reference to the accompanying drawings.

If a next-generation DVD is developed, a conventional DVD device (drive or player) cannot read data from the next-generation DVD since the next-generation DVD is substantially different from the existing DVD in recording density, modulation system, signal processing, track format, and the like. That is, the conventional DVD device has the disadvantage of being unable to read conventional DVD movie content recorded on the next-generation DVD as well as high definition movie content recorded on the next-generation DVD disc, which may lead to a factor that hinders the spread of the next-generation DVD.

Thus, in this embodiment, a single disc can deal with not only information (content) in a single-sided dual layer HD DVD but also information (content) in a single layer DVD.

One embodiment is based on the configuration of a single-sided triple layer optical disc comprising: a first recording layer which is accessed with a first laser beam; and a second recording layer and a third recording layer which are accessed with a second laser beam, these layers being arranged in this order in a direction in which the laser beams enter, wherein the distance of a light transmission layer from a light incidence plane to the first recording layer is a minimum of 550 μm, the distance between the first recording layer and the third recording layer is a maximum of 72 μm, the distance between the second recording layer and the third recording layer is a minimum of 19 μm, the distance between the first recording layer and the second recording layer is about 28 to 38 μm, the reflectivity of the first recording layer with respect to the first laser beam is 45% or more, and the areal recording density of the second recording layer and the third recording layer is three times or more as high as the areal recording density of the first recording layer.

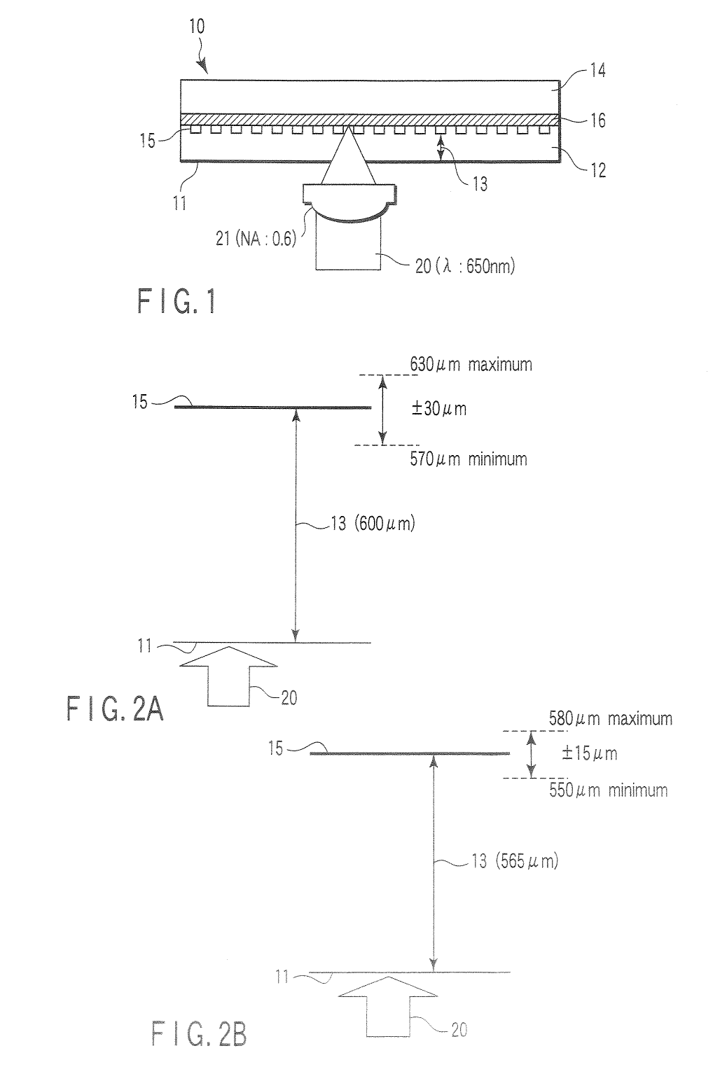

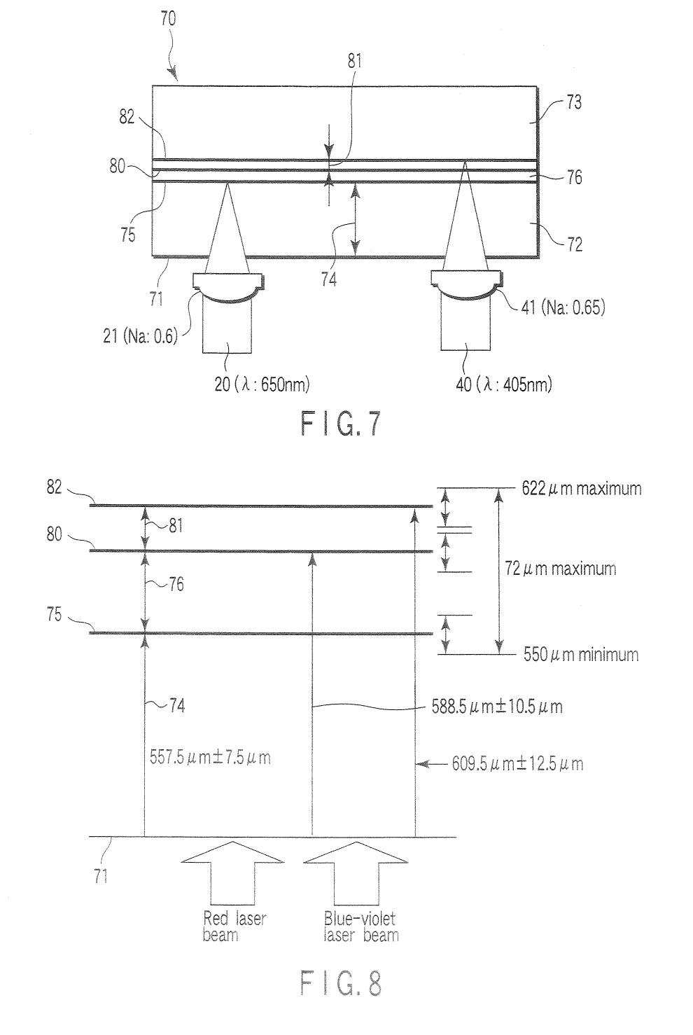

Hereinafter, this embodiment will be concretely explained referring to the drawings. To make it easier to understand the present invention, the technologies of the existing DVD and the next-generation DVD (HD DVD) will first be explained using FIGS. 1 to 6. Then, the basic configuration of a next-generation DVD according to the present invention will be explained using FIG. 7.

<Single-Sided Single Layer DVD>

FIG. 1 shows the relationship between the basic structure of a single-sided single layer DVD disc 10 and an optical head. As is well known, the DVD disc 10 has a structure in which two disc substrates having a thickness of 0.6 mm are bonded together. One of the substrates is a signal substrate 12 and the other is a dummy substrate 14. These substrates are bonded together with an adhesive layer 16 in such a manner that a DVD SL layer 15 which is a recording layer lies between the two substrates. Generally, these substrates are formed of a plastic material called polycarbonate by use of an injection molding machine.

It is to be noted that in the signal substrate 12, video information, data information and the like are formed in a spiral track in the form of emboss pits. A red laser beam 20 (waveform: 650 nm) for reading the information in the recording layer is narrowed down by an objective lens 21 (NA: 0.6), and focused on the DVD (SL) layer 15 through a light transmission layer 13 of the signal substrate 12.

FIGS. 2A and 2B are diagrams showing the position of the recording layer of the single-sided single layer disc when viewed from an incidence plane 11. FIG. 2A concerns a conventionally used single layer standard type, wherein the center value of the thickness of the light transmission layer 13 is 600 μm and lies in a position a minimum of 570 μm and a maximum of 630 μm away from the incidence plane. These values are determined taking the spherical aberration of the objective lens 21 into account. Recently, a single layer thin type has been added to the single-sided single layer disc as a DVD standard (refer to the World Wide Web: dvdforum.org, or to DVD Book), wherein as shown in FIG. 2B, the center value of the recording layer is 565 μm and lies in a position a minimum of 550 μm and a maximum of 580 μm away from the incidence plane. In this disc, jitter is regulated to be below 7% to secure interchangeability in reading with a conventional apparatus, whereas in the single layer standard type, jitter is regulated to be below 8%.

On the other hand, although not described here, a dual layer DVD disc having two recording layers (L0 layer and L1 layer) is defined in the DVD. The capacity is 8.54 GB in the two layers, and the two recording layers can be accessed from one side.

<Reflectivities and Others of the Recording Layers>

The reflectivities of the DVD layers are determined as follows:

Single-layer disc: 45% to 85% (with PBS)

Dual layer disc: 18% to 30% (with PBS)

Identification information indicating the reflectivity, layer structure and the like of the disc is in Identification Data (ID) of a Data frame and in Physical Format Information (PFI) in a Control Data Zone (CDZ) located in a Lead-in area of the DVD LO layer 15. It is to be noted that a Burst Cutting Area (BCA) can not be formed in a DVD video in which images are dealt with.

<HD DVD>

On the other hand, as has been often reported in recent years, an HD DVD has been proposed wherein blue-violet semiconductor laser (hereinafter, referred to as blue-violet laser) is used to achieve a density three times or more that of DVD in order to satisfy a desire to store High Definition (HD) images onto a single disc. The HD DVD has been standardized in the DVD forum (refer to the World Wide Web: dvdforum.org. This has not been commercialized yet.).

The HD DVD has the same disc structure as that of a conventional DVD. A single-sided single layer HD DVD disc has a capacity of 15 GB and a single-sided dual layer DVD disc has a capacity of 30 GB. These large capacities have been realized by new technologies, including a shorter wavelength of laser light, a larger NA, a modulation system, and new signal processing (Partial Response and Maximum Likelihood (PRML)).

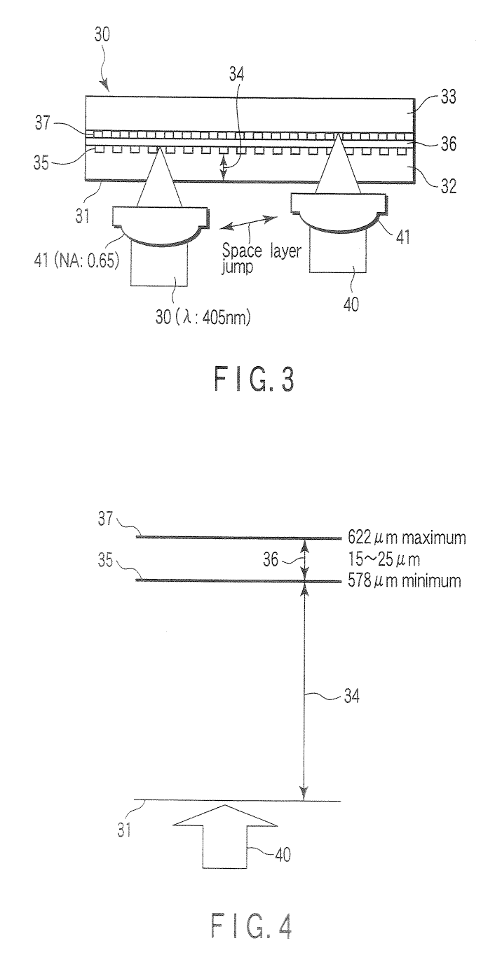

FIG. 3 shows the relationship between the basic structure of a single-sided dual layer HD DVD disc 30 and an optical head. In the HD DVD, a laser beam for reading information from the disc has been changed from a red laser beam (650 nm) to a blue-violet laser beam (405 nm) 40 to have a shorter wavelength, and NA of an objective lens 41 has increased from 0.6 to 0.65, resulting in a different spherical aberration and a different coma aberration caused by a tilt. Therefore, an actual disc is different from the DVD, for example, in terms of the position of an HD DVD L0 layer 35 and an HD DVD L1 layer 37 from a light incidence plane 31 and in terms of the thickness of an space layer 36.

FIG. 4 shows the position of the layers of the single-sided dual layer HD DVD disc when viewed from the light incidence plane 31. Since the spherical aberration has become severer as a result of making the wavelength shorter and NA larger, the HD DVD L0 layer 35 is limited to a position a minimum of 578 μm away from the light incidence plane and the HD DVD L1 layer 37 is limited to a position a maximum of 622 μm away from the light incidence plane. The distance between the two layers (space layer 36) is set to be 15 to 25 μm.

On the other hand, the reflectivities of the HD DVD layers are determined as follows:

Single-layer disc: 40% to 70% (including birefringence)

Dual layer disc: 18% to 32% (including birefringence)

As in a DVD, identification information indicating the reflectivity, layer structure and the like of the disc is in ID of a Data frame and in PFI in a CDZ located in a System Lead-in area of the HD DVD L0 layer 35. In addition, in the HD DVD, identification information, content protection information and the like for the disc are provided in a BCA formed inside the Lead-in area. This BCA is formed in the HD DVD L1 layer 37.

<Existing DVD and HD DVD>

Thus, the high-capacity HD DVD capable of storing HD images has been proposed. An HD DVD device (drive or player) newly designed for the HD DVD can be designed to be able to read data from not only an HD DVD disc but also a DVD. However, since this HD DVD disc is substantially different from the existing DVD in the recording density, modulation system, signal processing, track format, and the like, a conventional DVD device (drive or player) cannot read information recorded thereon. That is, the conventional DVD device has the disadvantage of being unable to read not only the high definition movie contents recorded on the HD DVD disc but also the conventional DVD movie contents. In order to cope with the problem, an HD DVD/DVD Twin format disc having an HD DVD recording layer and a DVD recording layer has recently been standardized in the HD DVD format (refer to the World Wide Web: dvdforum.org).

<HD DVD/DVD Twin Format Disc>

The Twin format disc is a new disc which can be treated as a DVD disc in the conventional DVD device and can be treated as an HD DVD disc in the HD DVD device. Moreover, if a device compatible with both the formats is used, this disc permits information (such as content) in both the formats to be selected by a user and read.

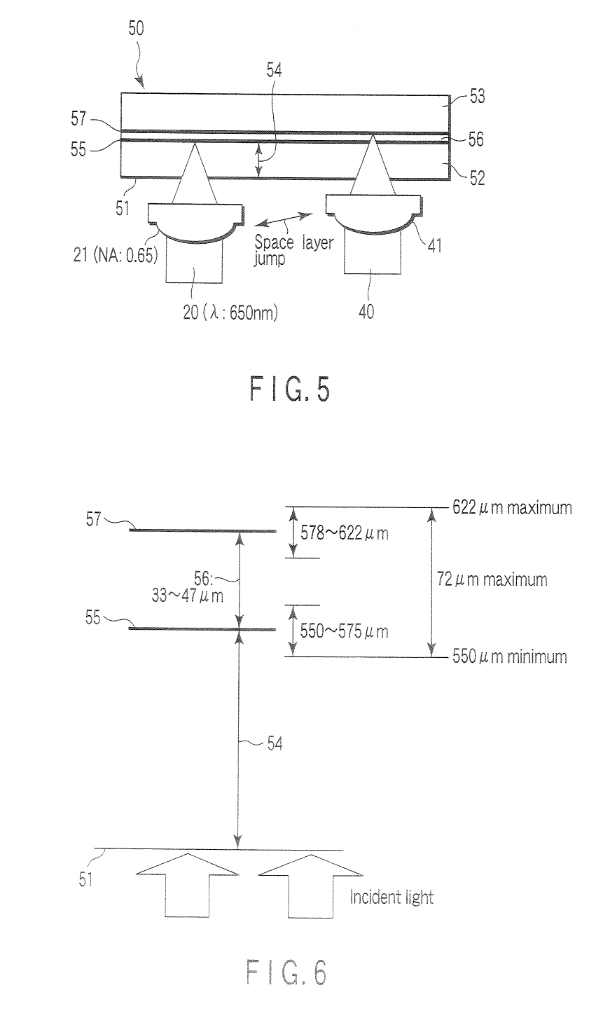

FIG. 5 shows the relationship between the basic structure of an HD DVD/DVD Twin format disc and an optical head. A Twin format disc 50 comprises a DVD substrate 52 where a DVD SL layer is formed, an HD DVD substrate 53 where an HD DVD SL layer is formed, and an space layer 56. When viewed from a light incidence plane 51, there are formed a DVD SL layer 55 and an HD DVD SL layer 57 in this order.

FIG. 6 shows the relationship of the position of the recording layers in the Twin format disc. From the light incidence plane 51, the DVD SL layer 55 is positioned 550 to 575 μm and the HD DVD SL layer 57 is positioned 578 to 622 μm, while the space layer 56 ranges from 33 to 47 μm therebetween. It is to be noted that the maximum distance between the DVD SL layer 55 and the HD DVD SL layer 57 is 72 μm.

Furthermore, the reflectivity of this disc when read with the red laser beam 20 is regulated as follows:

DVD layer: 45 to 85%

HD DVD layer: below 8%

In the current single-sided single layer DVD, there is no regulation of the reflectivities of other layers, but the reflectivity of the HD DVD layer is regulated so that it can be successfully read by the current DVD devices.

On the other hand, the reflectivity when reading with the blue-violet laser beam 40 is regulated as follows:

HD DVD layer: 14 to 28%

As just described, the Twin format disc has been standardized in the HD DVD format, such that the conventional DVD device can also read the DVD information.

Identification information indicating the reflectivity, layer structure and the like of this disc is in the DVD SL layer 55 and the HD DVD SL layer 57. Moreover, in the HD DVD SL layer 57, a BCA is formed inside the Lead-in area.

However, since one HD DVD layer is only defined in this Twin format disc, there is a disadvantage that this disc, as a next-generation DVD, has half the capacity of the dual layer HD DVD disc. Therefore, the present inventors have devised an optical disc, an optical disc apparatus, an optical disc reproducing method, and a digital work publication using the optical disc as a medium which enable a single disc to deal with not only the information (content) in the dual layer HD DVD but also the information (content) in the single-sided single layer DVD. Hereinafter, specific embodiments thereof will be explained.

<Basic Configuration of an Optical Disc and a Manufacturing Process>

FIG. 7 shows the relationship between an optical disc according to one embodiment of the present invention and an optical head. In an optical disc 70, there are formed, from a light incidence plane 71 in order, a first signal substrate 72, a first recording layer (DVD SL layer) 75, a first space layer 76, a second recording layer (HD DVD L0 layer) 80, a second space layer 81, and a third recording layer (HD DVD L1 layer) 82. Data is read from the DVD SL layer 75 through an objective lens 21 with a red laser beam 20, and data is read from the HD DVD L0 layer 80 and L1 layer 82 through an objective lens 41 with a blue-violet laser beam 40.

From the light incidence plane 71, the DVD SL layer 75 is located a minimum of 550 μm, while the HD DVD L1 layer 82 is located a maximum of 622 μm. Thus, an allowable distance between the two layers is a maximum of 72 μm. The three recording layers including the DVD SL layer, the HD DVD L0 layer and L1 layer can be arranged within 72 μm as far as practical manufacture is permitted. However, it is required that the reflectivity of the DVD SL layer when read with the red laser beam satisfy 45% or more of the standard in terms of the compatibility with the existing DVD player and that the reflectivity of the rest of the layers be below 8% as in the Twin format disc.

On the other hand, when data is read from the HD DVD layer with the blue-violet laser beam, the HD DVD L0 layer 80, in particular, is influenced by space layer crosstalk from the HD DVD L1 layer 82 and the DVD SL layer 75. Thus, not only manufacturing accuracy but also the influence of the space layer crosstalk have to be considered to decide the thickness of the first space layer 76 and the second space layer 81.

FIG. 8 shows one example of how to design the thickness of the substrates and space layer thickness when what has been described above is considered. The current technique permits an accuracy up to about ±7.5 μm in the injection molding of the first signal substrate 72 given the manufacturing accuracy and attachment accuracy of a stamper. Naturally, it is presumed that the accuracy can be further increased in the future. On the other hand, the thickness of the space layer is originally a minimum of 15 μm in the dual layer HD DVD. However, in the optical disc of the present invention, since the space layer crosstalk is also caused from the DVD SL layer, the minimum value of the space layer distance is 19 μm, and the ratio between the reflectivities in the dual layer HD DVD is restricted to a certain value. Thus, even if the space layer distance is reduced, it is possible to prevent the space layer crosstalk from increasing.

The HD DVD L0 layer is formed on the HD DVD L1 layer formed on a second signal substrate by a 2P method, and an accuracy of the formation can be about ±2 μm. Then, the first signal substrate on which the DVD SL layer is formed is bonded to the second signal substrate via the space layer 76 in such a manner that the recording layers lie between the two substrates. Here, the minimum value of the thickness of the space layer is 28 μm in terms of the space layer crosstalk (this will be described later). The thickness of this size permits bonding with an accuracy of about ±3 μm using a recent vacuum bonding technique. As a result, the DVD SL layer 75, and the HD DVD L0 layer 80 and L1 layer 82 can be formed within a distance of 72 μm in a range where the space layer crosstalk does not matter. It is to be noted that, here, an Ag alloy is used for the first recording layer and the second recording layer serving as translucent films and an Al alloy is used for the highly reflective third recording layer.

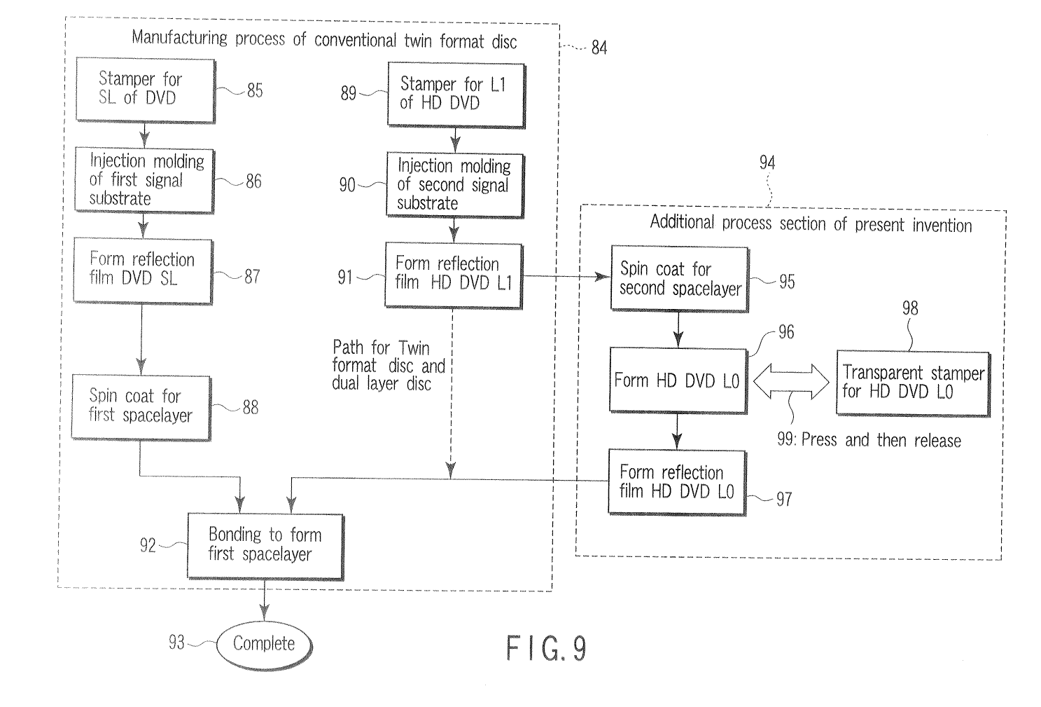

FIG. 9 shows an example of a process of manufacturing an optical disc of the present invention. 84 denotes about the same process as the process of manufacturing a dual layer disc or a conventional Twin format disc. On the left side, there are steps of forming the first signal substrate 72 and the DVD SL layer 75 which is the first recording layer. On the right side, there are steps of forming the HD DVD L1 layer 82 which is the third recording layer on a second signal substrate 73. In the manufacture of the disc of the present invention, an additional process 94 is added to the above process in order to form the HD DVD L0 layer which is the second recording layer on the HD DVD L1 layer formed on the second signal substrate. Then, the first signal substrate and the second signal substrate are bonded together in such a manner that the recording layers lie between the two substrates, such that the disc of the present invention can be manufactured.

Each of the processes will be briefly explained. In processes 85 to 88, by use of a stamper for the DVD SL layer, the first signal substrate is injection-molded, and a reflection film for the SL layer is formed, and then the first space layer is formed by spin coating. In processes 89 and 90, by use of a stamper for the HD DVD L1 layer, the second signal substrate is injection-molded, and a reflection film for the L1 layer is formed. Next, in the above-mentioned process 94, the second space layer is formed by spin coating (process 95), the HD DVD L0 layer is formed (processes 96 and 98), and a reflection film for the L0 layer is formed (process 97). Then, the first signal substrate and the second signal substrate are finally bonded together (process 92).

In the above explanation, the third recording layer is formed on the second signal substrate, on which the second recording layer is formed. However, it will be appreciated that the first recording layer may be formed on the first signal substrate, on which the second recording layer may be formed.

<Reflectivities of the Respective Layers>

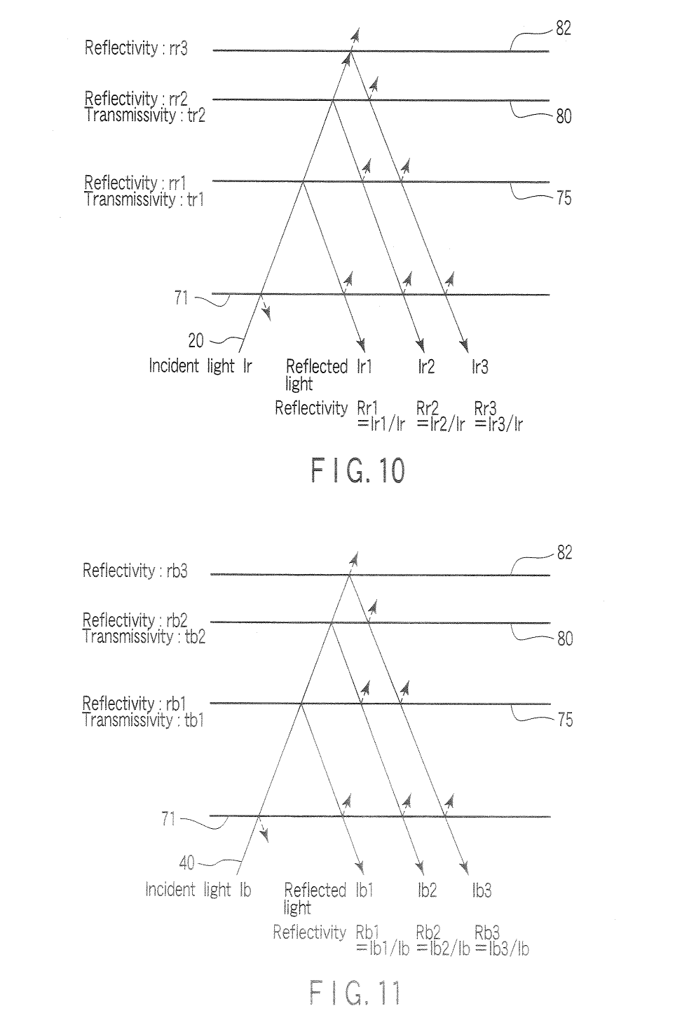

FIG. 10 shows the relationship between light reflected from the respective layers and the reflectivity thereof when the red laser beam (Ir) 20 has entered the optical disc 70 of the present invention. The reflectivities of the respective layers can be calculated by use of the reflectivities and transmissivities of the respective recording films. However, the loss in the incidence plane is 10%, and the effects of the birefringence are considered later and are not included in these equations.

The reflectivity of the DVD SL layer 75 which is the first recording layer:
Rr1=Ir1/Ir≅0.9×rr1 (1)

The reflectivity of the HD DVD L0 layer 80 which is the second recording layer:
Rr2=Ir2/Ir≅0.9×(tr1)²×rr2 (2)

The reflectivity of the HD DVD L1 layer 82 which is the third recording layer:
Rr3=Ir3/Ir≅0.9×(tr1)²×(tr2)²×rr3 (3)

In the same manner, FIG. 11 shows the relationship between light reflected from the respective layers and the reflectivity thereof when the blue-violet laser beam (Ib) 40 has entered the optical disc 70 of the present invention. The reflectivities of the respective layers can be calculated by use of the reflectivities and transmissivities of the respective recording layers. However, the loss in the incidence plane is 10%, and the effects of the birefringence are considered later and are not included in these equations.

The reflectivity of the DVD SL layer 75:
Rb1=Ib1/Ib≅0.9×rb1 (4)

The reflectivity of the HD DVD L0 layer 80:
Rb2=Ib2/Ib≅0.9×(tb1)²×rb2 (5)

The reflectivity of the HD DVD L1 layer 82:
Rb3=Ib3/Ib≅0.9×(tb1)2×(tb2)²×rb3 (6)

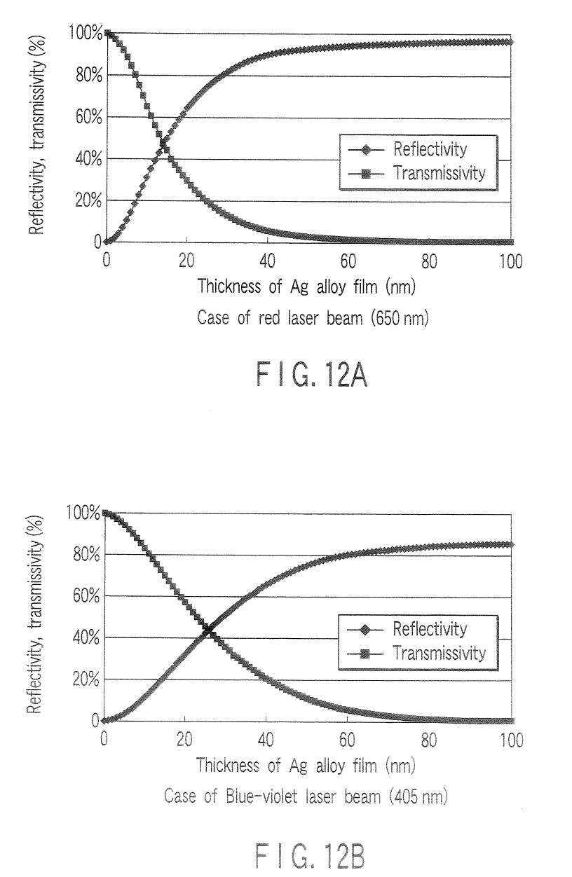

In FIGS. 12A and 12B, three samples of Ag alloy films having different thickness to be used as the translucent films are manufactured, and the reflectivities and transmissivities dependent on the thickness of the Ag alloy films are calculated as to the red laser beam and the blue-violet laser beam on the basis of the values of the reflectivities and transmissivities which have been actually measured using the red laser beam and the blue-violet laser beam. The subsequent calculations of the reflectivity are performed using the values of the Ag alloy films in this graph.

Specifically, the Ag alloy film is used for the first recording layer (DVD SL layer) and the second recording layer (HD DVD L0 layer), and an Al alloy film is used for the third recording layer (HD DVD L1 layer), thereby calculating the reflectivities of the respective layers. In FIGS. 12A and 12B, attention should be paid to a cross point between a curve indicating the reflectivity and a curve indicating the transmissivity when the red laser beam is used, and to a cross point between a curve indicating the reflectivity and a curve indicating the transmissivity when the blue-violet laser beam is used. The cross point is lower than 20 nm in FIG. 12A, while the cross point is higher than 20 nm in FIG. 125. The present invention takes advantage of an area between these two cross points.

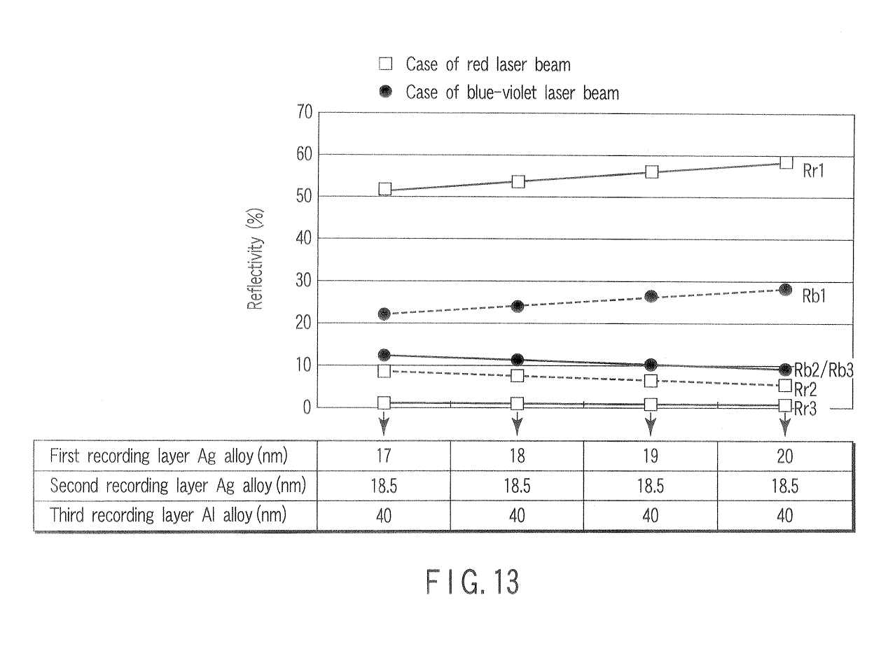

FIG. 13 is a graph showing the reflectivities of the first recording layer (SL layer), the second recording layer (L1 layer) and the third recording layer (L3 layer) calculated when data is read therefrom with the red laser beam, and the reflectivities of the first recording layer (SL layer), the second recording layer (L0 layer) and the third recording layer (L1 layer) calculated when data is read therefrom with the blue-violet laser beam. The calculations were performed so that the reflectivity of the SL layer 75 with respect to the red laser beam is 50% or more (considering a decrease due to the birefringence) and so that the L0 layer and L1 layer have about the same reflectivity. It is to be noted that the calculations do not include the decrease of the reflectivity due to the birefringence.

In FIG. 13, Rr1, Rr2 and Rr3 indicate the reflectivities of the first recording layer (SL layer), the second recording layer (L0 layer) and the third recording layer (L1 layer). The reflectivity of the third recording layer is significantly low and therefore negligible. However, the reflectivity of the second recording layer is a little less than 9%, which is not a negligible level. The thickness of the Ag alloy of the first recording layer can be increased to decrease the reflectivity, but this, on the other hand, increases the reflectivity of the first recording layer with respect to the blue-violet laser beam and, at the same time, decreases the reflectivities of the second recording layer and the third recording layer with respect to the blue-violet laser beam. Therefore, both of the above have to be considered to decide a suitable range because the reflectivity of the first recording layer matters a great deal in the case of the blue-violet laser beam.

In FIG. 13, Rb1, Rb2 and Rb3 indicate the reflectivities of the first recording layer (SL layer), the second recording layer (L0 layer) and the third recording layer (L1 layer) with respect to the blue-violet laser beam.

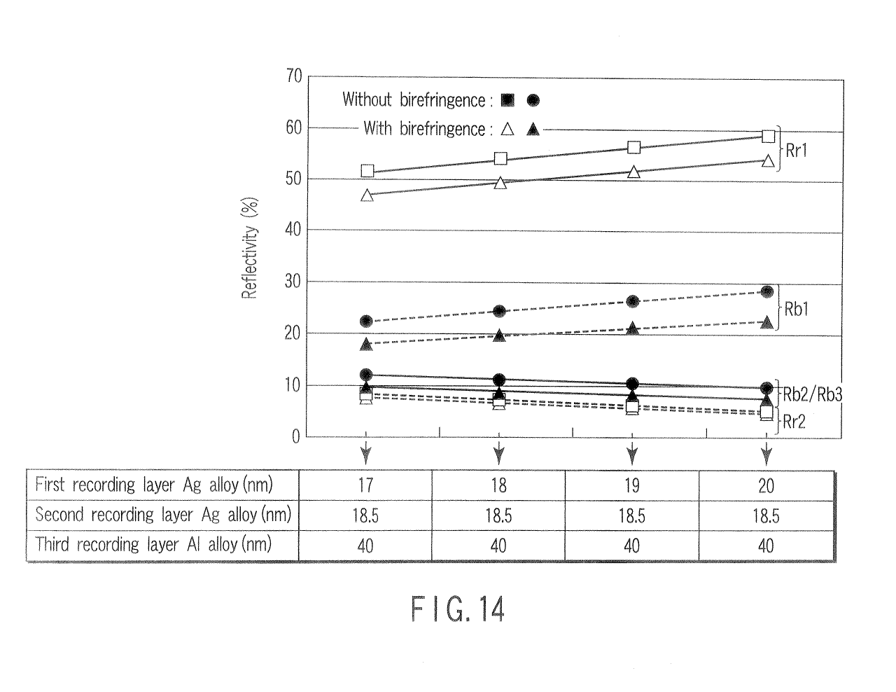

FIG. 14 shows cases with and without a birefringence at a maximum value of 60 nm of the HD DVD standard (the decrease of reflectivity due to the birefringence is calculated to be a maximum loss of 8.2% in the case of the red laser beam and to be a maximum loss of 20% in the case of the blue-violet laser beam). It is to be noted that the reflectivity of the third recording layer with respect to the red laser beam is significantly low and not shown in the drawing.

<Reflectivity when the Disc is Played Back with the Red Laser Beam, and the Thickness of the Space Layer>

Now, when data is read from the disc of the present invention with the red laser beam, the reflectivity of the first recording layer (DVD SL layer) 75 has only to be 45% or more even if the birefringence is a maximum of 60 nm. It is understood from FIG. 14 that Rr1 can satisfy this condition if the thickness of the Ag alloy of the first recording layer is 17 nm or more.

On the other hand, due to the regulation of the Twin format disc, the reflectivity of the second recording layer (HD DVD L1 layer) 80 which is an adjacent recording layer needs to be below 8% so that the disc can be played back on the existing DVD player. It can be understood from Rr1 in FIG. 13 that this condition can be satisfied if the thickness of the Ag alloy film of the first recording layer is larger than about 18 μm (Rr2 is below 8%). It is to be noted that the reflectivity of the third recording layer is about 1% and therefore negligible.

When data is read from the first recording layer (DVD SL layer) 75 with the red laser beam, the first space layer 76 formed between the first recording layer 75 and the second recording layer 80 is not particularly limited as long as the reflectivity of the second recording layer 80 is below 8%. That is, in the playback with the red laser beam, the reflectivity (Rr2) of the second recording layer is 7.4% or less and a reflectivity below 8% can be achieved as long as the thickness of the Ag film of the first recording layer is 18 nm or more.

<Reflectivity in Playback with the Blue-Violet Laser Beam, Space Layer Crosstalk and the Thickness of the Space Layer>

In the above examination, it has been shown that the thickness of the Ag film of the first recording layer only has to be larger than 18 μm when the first recording layer of the disc of the present invention is played back with the red laser beam.

However, as understood from FIG. 13, when the disc of the present invention is played back with the blue-violet laser beam, an increase in the thickness of the Ag alloy of the first recording layer 75 will lead to a decrease of the reflectivities Rb2 and Rb3 of the second and third recording layers and an increase in the reflectivity Rb1 of the first recording layer which becomes the space layer crosstalk toward the second recording layer. Therefore, it is presumed that the thickness of the Ag alloy of the first recording layer is optimized in a certain range

Now, attention is focused on the second recording layer to consider the space layer crosstalk. In the conventional dual layer HD DVD, the thickness of the space layer is 20 ±5 μm, the reflectivity is 18 to 32%, and the space layer crosstalk is caused between the L0 layer and the L1 layer. However, in the present invention, the L0 layer serving as the second recording layer is influenced by the space layer crosstalk not only from the L1 layer which is the third recording layer but also from the SL layer which is the first recording layer.

As has been shown in FIGS. 13 and 14, the reflectivities of the respective layers are automatically decided when the material of the recording films forming the respective recording layers is decided. Thus, in order to decrease the space layer crosstalk, it is necessary to reduce the distance between the first space layer and the second space layer, and the ratio between the reflectivities of the HD DVD L0 layer and the HD DVD L1 layer which are allowed in a range of 18 to 32%.

In the dual layer HD DVD, the highest space layer crosstalk theoretically allowed is caused when the distance of the space layer is 15 μm and the ratio between the reflectivities is 32/18=1.78. However, there is always a change in the reflectivities of the two recording layers, and if the ratio between the reflectivities is about ±10%, the highest space layer crosstalk allowed will bring about an equivalent reflectivity ratio of 32/18/(1.1/0.9)=1.45.

Now, if the minimum value of the distance of the second space layer of the present invention is d μm and a change of the reflectivity is ±10%, the space layer crosstalk caused thereby results in (15/d)²×(1.1/0.9).

On the other hand, if the thickness of the first space layer is f μm, the influence of the space layer crosstalk from the DVD SL layer results in (15/f)²×(Rb1/Rb2). It is to be noted that (Rb1/Rb2) is not influenced by the birefringence.

The space layer crosstalk will hereinafter be considered on the assumption that the thickness of the Ag alloy is 18 μm. From the viewpoint of the space layer crosstalk, the second space layer should be as thick as possible, but if it has a large thickness, it is difficult to put the three recording layers within a permissible value of 72 μm. Thus, here, if a minimum value of 19 μm is used which is a value used in a design example, the space layer crosstalk from the L1 layer is:
(15/19)2×(1.1/0.9)=0.762.

On the other hand, the space layer crosstalk from the DVD SL layer is:
(15/f)²×(24.2%/11.2%).

The sum of the space layer crosstalks toward the L0 layer is:
0.762+(15/f)²×(24.2%/11.2%)<1.45
f>26.6 μm.

Next, if the thickness of the Ag alloy of the first recording layer is 19 μm, the space layer crosstalk from the DVD SL layer is:
(15/f)²×(26.3%/10.3%)<1.45
f>28.9 μm.

From the above examination, if the thickness of the space layer is 28 μm or more, the space layer crosstalk can be satisfied at the worst. It is to be noted that the upper limit of the thickness of the space layer is a value decided by the formation accuracy of the first signal substrate and the formation accuracy of the first space layer and the second space layer, and 34 μm is used in the design example, but it is considered that it can be increased to about 38 μm in the future.

It is to be noted that from FIG. 14, the reflectivity of the second recording layer is 11.2% when the thickness of the Ag alloy film of the first recording layer is 18 μm and there is no birefringence, while the reflectivity of the second recording layer is 7.7% when the thickness of the Ag alloy film is 20 μnm and there is birefringence. Thus, the range of the reflectivity should be about 7 to 12%. In addition, the ratio between the reflectivities of the second recording layer and the third recording layer needs to be within about ±10%.

<Flag Information>

Next, a set of flags in the optical disc of the present invention will be explained. In the optical disc of the present invention, the first recording layer serves as a single layer DVD disc, so that in the Identification Data (ID) composed of four bytes of the Data frame of the DVD SL layer 75, bit positions b29 and b24 are written as

b29 (reflectivity): 0b (when the reflectivity is larger than 40%)

b24 (layer number): 0b (in the case of the SL).

b6b5 of a byte position (BP2) of the Physical Format Information (PFI) in the Control Data Zone (CDZ) in the Lead-in area formed in the DVD SL layer 75 indicates the number of layers in the disc, so that

b6b5 (number of layers): 00b (one layer) is written.

Moreover, (BP16) indicates the presence of the Burst Cutting Area (BCA), and there must not be the BCA in a DVD video, so that

b7 (BCA flag): 0b (without BCA) is written.

It is to be noted that (BP0) to (BP31) are common in a DVD family, and (BP32) to (BP2047) may be used in the respective discs. In the Twin format disc, (BP33) is newly defined:

B7 (Twin Format Disc)

0b: DVD-ROM disc (disc is not Twin format disc)

1b: HD DVD-ROM/DVD-ROM Twin format disc.

Therefore, in (BP33), there is written

b7 (Twin format disc) 1b.

On the other hand, since the HD DVD L0 layer 80 corresponds to the L0 layer of the dual layer HD DVD disc, the ID composed of four bytes of the Data frame is written as

b24 (layer number): 0b (L0 of dual layer).

Moreover, since the HD DVD L1 layer 82 corresponds to the L1 layer of the dual layer HD DVD disc, the ID composed of four bytes of the Data frame is written as

b24 (layer number): 1b (L1 of dual layer)

b6b5 of (BP2) of the PFI in the Control data zone in the Lead-in area formed in the HD DVD L0 layer 82 indicates the number of layers in the disc, so that

b6b5 (number of layers): 01b (two layers) is written if it is used as it is.

However, since the disc of the present invention actually has three layers,

b6b5 (number of layers): 10b (three layers) is better.

(BP16) indicates the presence of the BCA, so that

b7 (BCA flag): 1b (with BCA) is written.

Furthermore, in the HD DVD/DVD Twin format disc, there are regulations of the Twin format disc for the conventional single layer DVD and single layer HD DVD, so that (BP33) includes

Layer 1 (b5-b3): 000b (HD DVD-ROM format)

Layer 0 (b2-b0): 10b (DVD-ROM format).

Note that since the disc of the present invention has a triple-layer structure, this regulation for the dual layer structure is not applied. However, it can be judged that there are two HD DVD layers if the HD DVD layers are accessed, and it is therefore possible to use the regulation as it is.

However, it is truly more convenient if it can be recognized that there are two HD DVD layers when the HD DVD layer is accessed. In this case, for example, 001b (dual layer HD DVD-ROM format) has only to be newly defined in layer 1 (b5-b3).

Next, flag information of the BCA will be explained. A BCA record of the HD DVD has 8 bytes, and (BP4) indicates a book type and a disc type. Since a Twin format flag indicating the Twin format disc is in b2 therein,

b2 (Twin format flag): 1b (Twin format disc) is written.

<Reproduction by an Optical Disc Apparatus Complying with the DVD Standard>

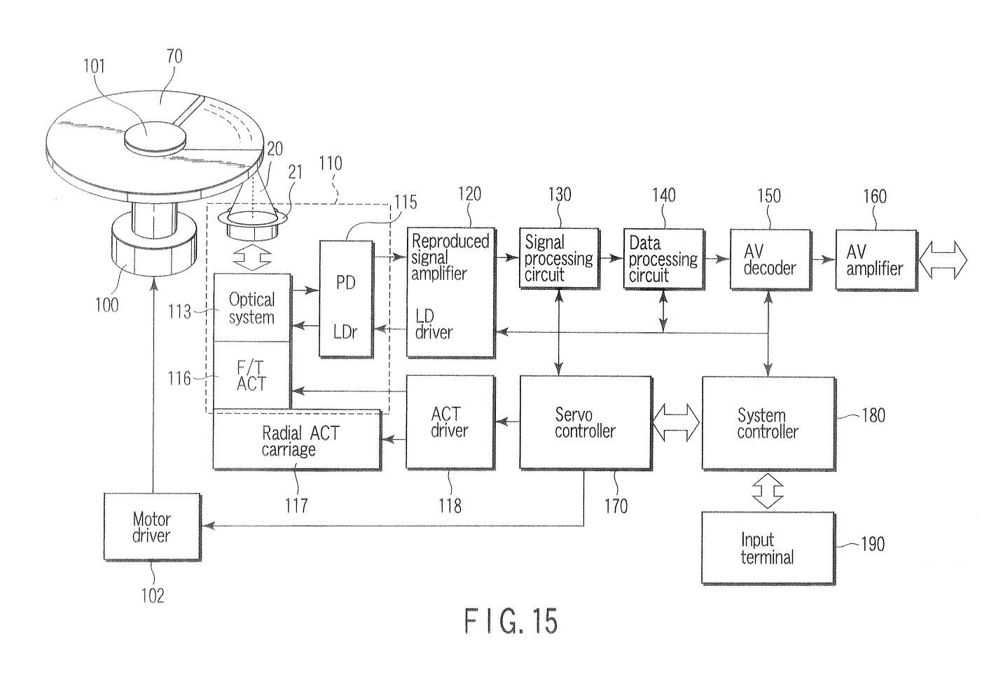

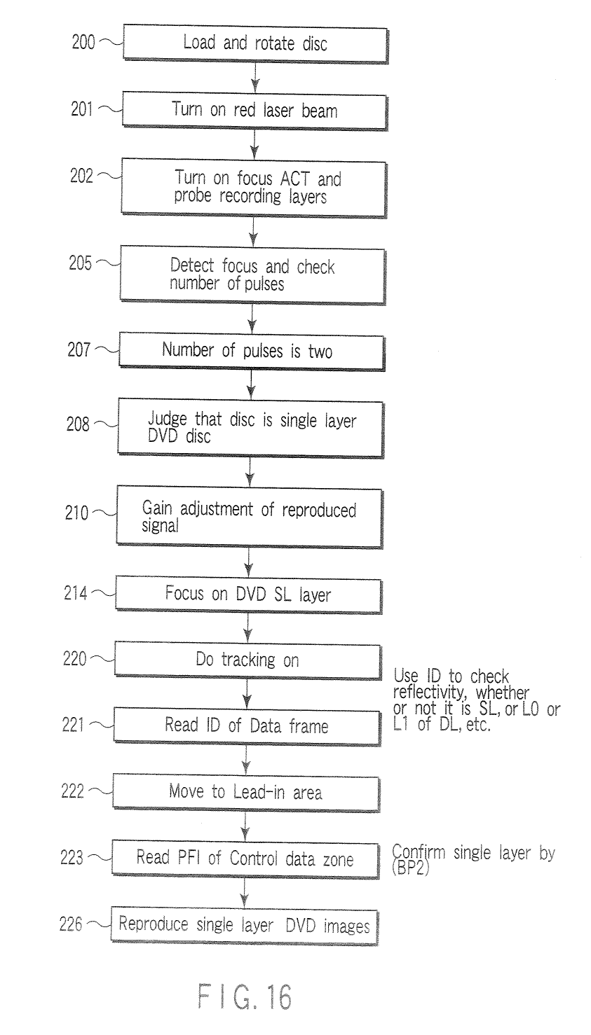

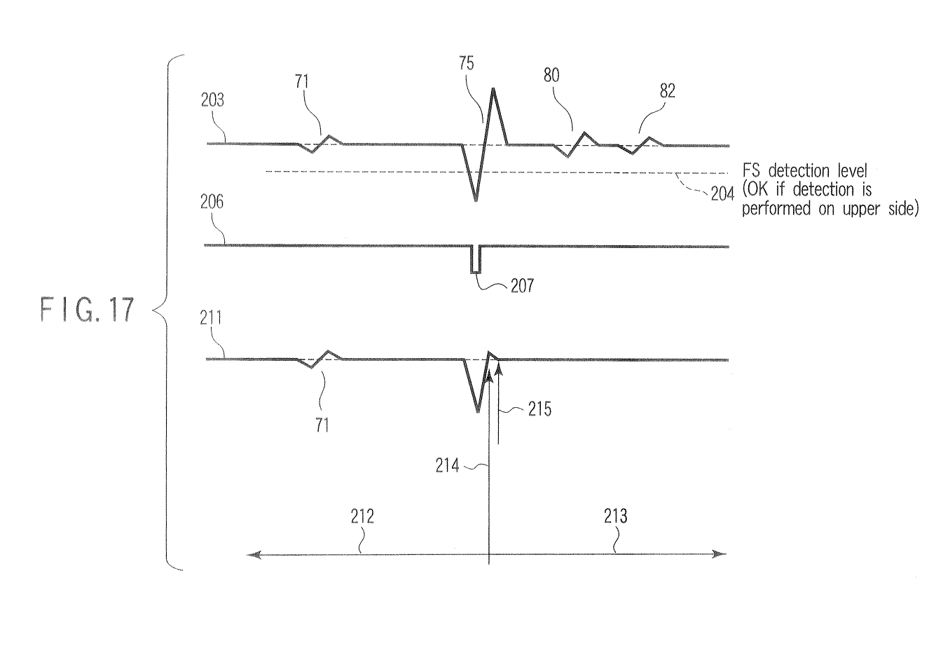

Next, a case where the optical disc of the present invention is played back on a conventional DVD player will be explained using FIGS. 15, 16 and 17. FIG. 15 shows the main configuration of a well-known conventional DVD player. FIG. 16 is a flowchart to help explain the operation of the DVD player. FIG. 17 shows focus signals and a focus servo.

A spindle motor 100 rotates/drives a turntable. A clamper 101 holds the optical disc 70 onto the turntable. The spindle motor 100 is controlled by a motor driver 102. An optical head 110 includes the objective lens 41 and an optical system 113. The optical system 113 is driven by a focus and tracking actuator 116. When the focus and tracking actuator 116 is controlled by an actuator driver 118, the laser beam is focused on a track on the optical disc and follows the track. A radial actuator 117 is used to move the optical head 110 in the direction of radius of the disc and is controlled by the actuator driver 118.

The reflected light from the disc is taken out of the optical system 113 and is converted into an electrical signal at a photodetector in a conversion unit 115. The electrical signal is gain-adjusted at a reproduced signal amplifier in a gain adjusting unit 120 and the resulting signal is input to a signal processing circuit 130. The signal processing circuit 130 performs a demodulating process, buffering, error correction, and others and inputs the resulting signal to a data processing circuit 140. Here, the data processing circuit 140 performs packet separation, control signal separation, and the like and inputs video and audio information to an AV decoder 150. The video signal, audio signal, sub-video signal, and the like demodulated at the AV decoder 150 are output as a baseband signal via an AV amplifier 160, and input to a monitor.

Using a focus error signal and tracking error signal obtained by, for example, numerically processing the reproduced signal from a 4-quadrant photodiode, a servo controller 170 supplies a control signal to the actuator (ACT) driver 118. In response to a signal from an input terminal (e.g., a remote controller or an operation key input section) 190, a system controller 180 controls the playback, stop, and temporary stop of the apparatus, and the like. In addition, the system controller 180 controls a laser diode driver in the gain adjusting unit 120. The laser diode driver drives the laser diode installed in the optical head 110, thereby outputting a laser beam.

When the optical disc 70 of the present invention is installed in the DVD player, the spindle motor 100 is rotated until a specific number of revolutions has been reached (in step 200 in FIG. 16). Next, the red laser beam 20 is turned on, and a periodic driving current is caused to flow through the focus actuator (ACT) 116, thereby moving the optical head up and down in the direction of axis (in steps 201 and 202 in FIG. 16). A focus signal 203 produced from the reproduced signal periodically appears (see FIG. 17). The lowest reflectivity of the single layer DVD is 45%, so that if an FS detection level 204 is set to about half of that reflectivity, one detection pulse 207 is obtained in a focus detection signal 206 (in steps 205 and 207 in FIG. 16).

From the fact that one pulse has been obtained, this disc is judged to be a single layer DVD, and the focus signal obtained by the gain adjustment is used to focus on the DVD SL layer 75. After a while, the disc enters an on-focus state. Then, the disc is tracked on to read the ID of the Data frame (in step 221 in FIG. 16). Here, it is possible to check the reflectivity and whether the layer is the DVD SL layer or the L0 layer by looking at b29 and b24. Next, a signal is sent to the ACT driver 118, and the radial ACT carriage 117 is thus actuated to move the optical head 110 to the Lead-in area (222 in FIG. 16), and then the PFI in the Control Data Zone (CDZ) is read. Here, (BP2) is read to verify that the disc is a single layer DVD disc, and the disc is thus regarded as a single layer DVD, thereby performing image reproduction. The user can enjoy the images of the single layer DVD using the input terminal 190.

It is to be noted that some DVD players first detect whether or not the disc is a dual layer DVD disc. In this case, the FS detection level 204 is set at less than half of a lowest reflectivity of the dual layer disc of 18%. The focus detection signal 206 can be obtained not only from the DVD SL layer 75 but also from the second recording layer (the HD DVD L0 layer 80) shown in FIG. 13, so that there may be two pulses 207.

When two pulses have been detected, the playback operation is generally started on the assumption that the disc is a dual layer DVD, and the DVD L0 layer (the DVD SL layer 75 here) is focused on. Thus, steps after step 210 in FIG. 16 are the same, and the disc is finally regarded as a single layer DVD, thereby reproducing images.

Some apparatuses may focus on the DVD L1 layer. In this case, the recording layer erroneously recognized as the DVD L1 layer is actually the HD DVD L0 layer 80, and the tracking is not therefore successfully performed and no signal can be detected. Thus, this layer is judged not to be the DVD L1 layer, and the playback is performed returning again to the DVD L0 layer (actually the DVD SL layer 75), so that the disc is regarded as a single layer DVD and image reproduction is performed accordingly.

<Reproduction by an Optical Disc Apparatus Complying with the HD DVD Standard>

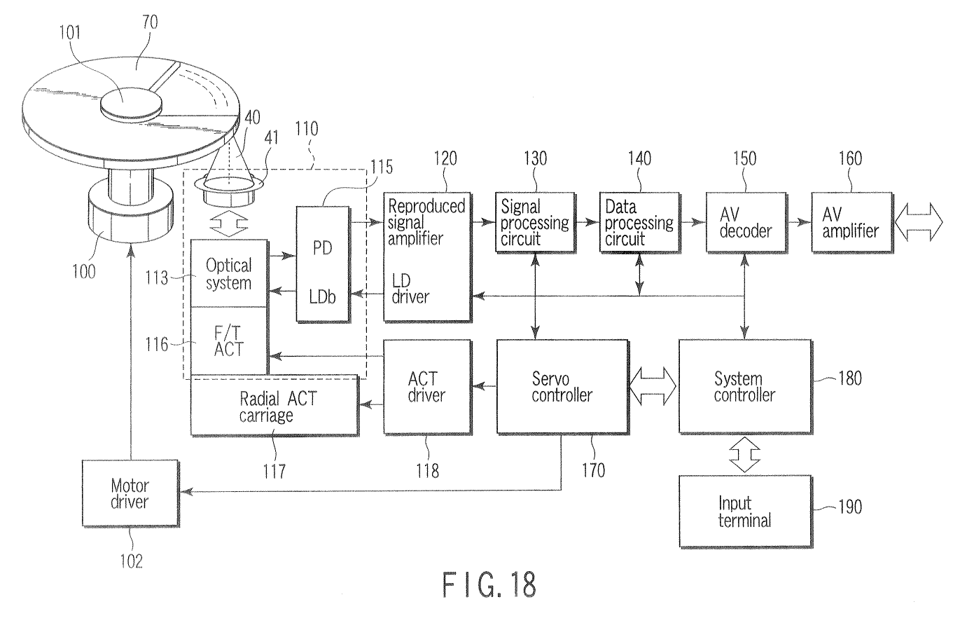

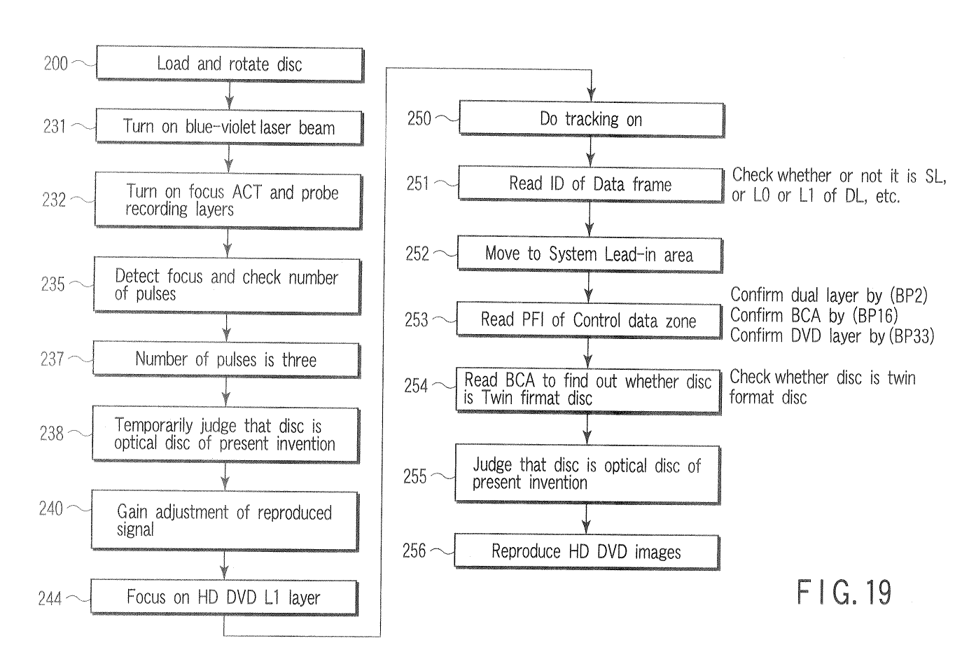

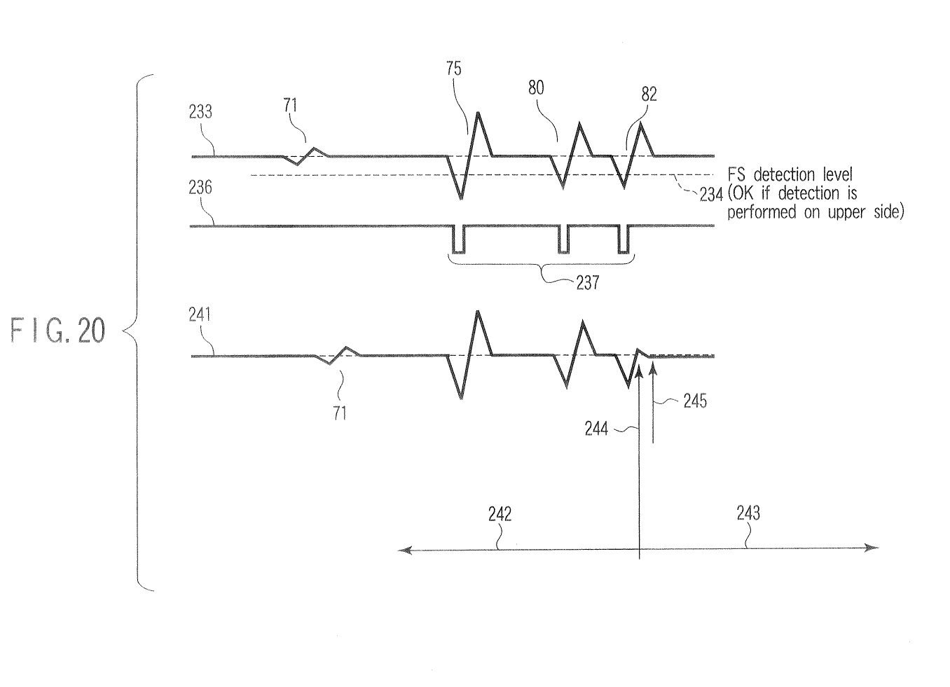

Next, a case of an HD DVD player using the blue-violet laser beam will be explained using FIGS. 18, 19 and 20. FIG. 18 shows the main configuration of the HD DVD player. FIG. 19 is a flowchart to help explain the operation of the HD DVD player. FIG. 20 shows focus signals and a focus servo. The configuration of the HD DVD player is similar to that of the apparatus shown in FIG. 15, and the same numerals are therefore given to similar parts.

When the optical disc 70 of the present invention is installed in the HD DVD apparatus, a spindle motor 100 is rotated until a specific number of revolutions per minute has been reached (in step 200 in FIG. 19). Next, the blue-violet laser beam 40 is turned on (in step 231 in FIG. 19), and a periodic driving current is caused to flow through a focus actuator ACT 116, thereby moving an optical head up and down in the direction of the axis (in step 232 in FIG. 19). A focus signal 233 produced from a reproduced signal periodically appears (see FIG. 20).

The lowest reflectivity of the dual layer HD DVD is 18% as in the dual layer DVD, the lowest reflectivity of the HD DVD layer of the Twin format disc is 14%, and the lowest reflectivity of the HD DVD layer of the disc of the present invention is 6%, so that 6% or less is set as an FS detection level 234. Although not shown here, a pulse is detected even by surface reflection if the detection level is 5% or less. However, this pulse can be excluded because the position where the pulse appears is quite different from the position in the case of the recording layer.

When the optical disc of the present invention is loaded in the player, three detection pulses 237 appear in a focus detection signal 236 (in steps 235 and 237 in FIG. 19). Therefore, this loaded disc is temporarily judged to be an optical disc of the present invention, thereby entering a sequence to play back the disc of the present invention (a final judgment is made in accordance with the PFI and the flag information of BCA).

After a gain adjustment of the reproduced signal is first made (in step 240 in FIG. 19), the HD DVD layer L1 82 is focused on (in step 244 in FIG. 19). After a short stabilization time has elapsed, the L1 layer 82 is in focused-on state (in step 245 in FIG. 19). Then, when a suitable position of the disc is tracked on (in step 250 in FIG. 19), the reproduced signal can be read. The optical head 110 is located at a given position of the disc, and reads the ID of the Data frame of the reproduced signal, thereby making it possible to judge whether the layer is the L0 layer or L1 layer of the dual layer HD DVD and whether the position is in the data area or in the Lead-in area (in step 251 in FIG. 19).

If the layer is identified as the L1 layer from the ID of the Data frame, the radial ACT 117 is driven, and the optical head is moved to the System Lead-in area (in step 252 in FIG. 19), and then the PFI in the Control Data Zone (CDZ) is read (in step 253 in FIG. 19). Here, it can be recognized from (BP2) that the disc has a triple layer structure, from (BP16) that the disc has a BCA, and from (BP33) that a DVD layer is formed in this disc. Subsequently, when the optical head is moved to the BCA and the BCA is read (in step 254 in FIG. 19), it is finally verified from (BP4) of BCA record ID that the disc is a Twin format disc of the present invention (in step 255 in FIG. 19), which is followed by the reproduction of dual layer HD DVD images (in step 256 in FIG. 19). The user can enjoy the dual layer HD DVD images using an input terminal 190.

<Reproduction by an Optical Disc Apparatus Complying with Both the HD DVD Standard and the DVD Standard>

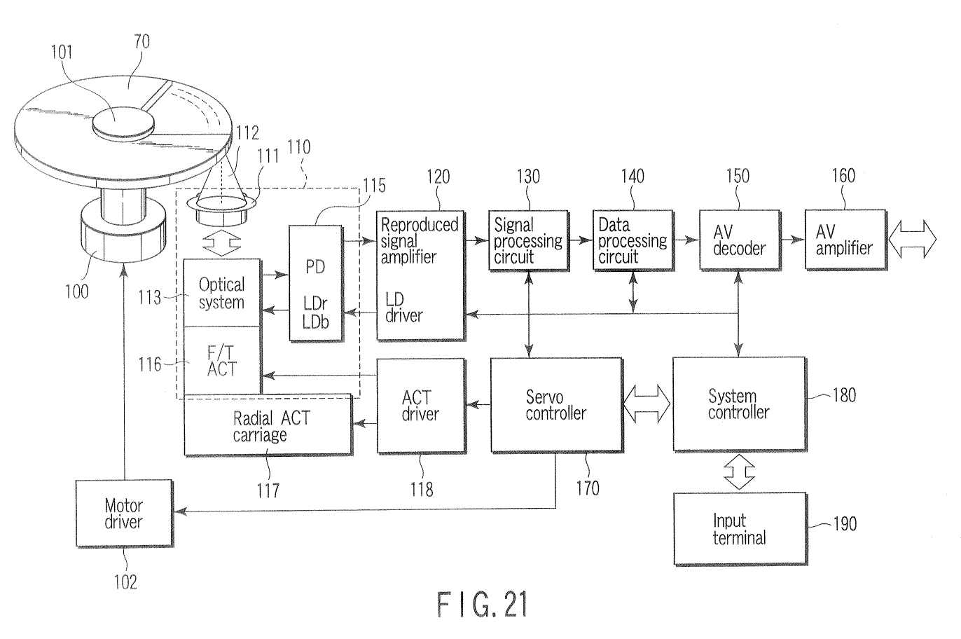

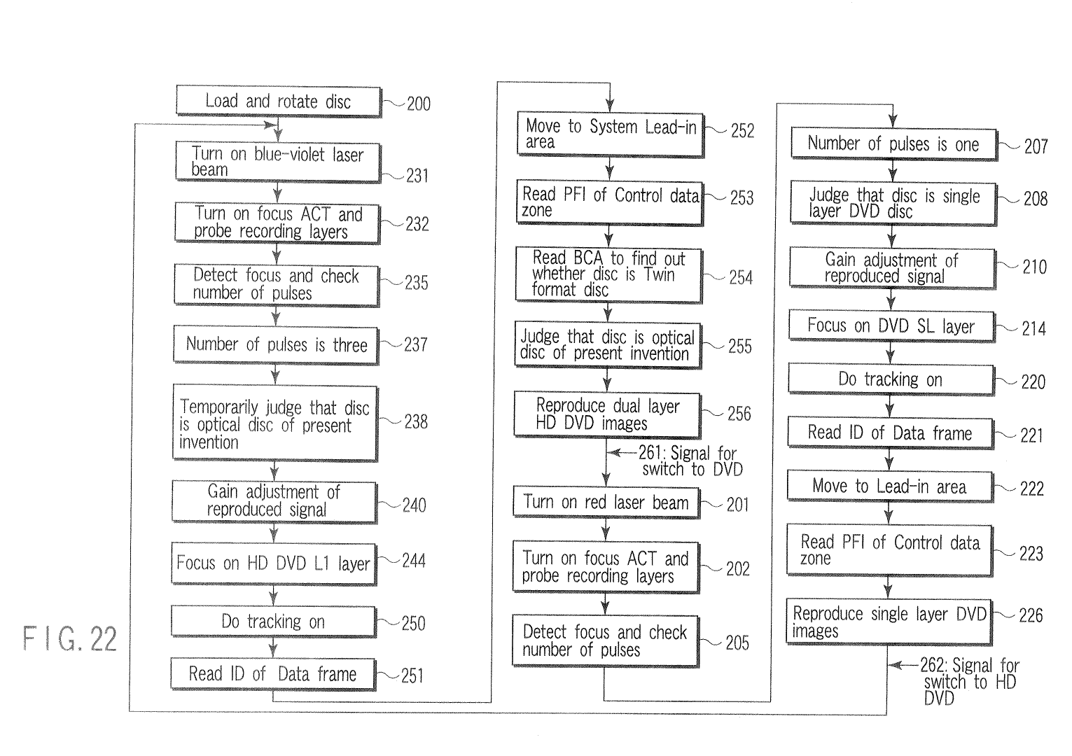

Next, a compatible player according to the present invention using both the blue-violet laser beam and the red laser beam will be explained using FIGS. 21 and 22. FIG. 21 shows the configuration of the compatible player. FIG. 22 is a flowchart to help explain the operation of the compatible player. The compatible player can selectively output the red laser beam and the blue-violet laser beam. The parts similar to those in the previously described players are given the same numerals.

First, a disc of the present invention is loaded in the compatible player, and the disc is rotated (in step 200 in FIG. 22). Next, the laser is turned on to move on to focusing/tracking, signal reproduction and image reproduction, wherein the blue-violet laser beam is first turned on (in step 231 in FIG. 22) to reproduce the images in the HD DVD layer.

The reproduction flow for the HD DVD images is the same as that in FIG. 19. The HD DVD layer L1 82 is focused on (in step 244 in FIG. 22). Then, the disc is tracked on (in step 250 in FIG. 22). The Data frame ID, the PFI of the System Lead-in area, and the BCA are read, thereby judging that this disc is an optical disc of the present invention and reproducing the images of the HD DVD. The user can enjoy the dual layer HD DVD images using an input terminal 190.

Next, when the user specifies the playback of the DVD by use of the input terminal 190, the red laser is turned on by a signal 261 to switch to the DVD (in step 201 in FIG. 22). This is followed by the same operation flow as that in FIG. 16, so that a focus actuator ACT 116 is driven, the recording layer is probed (in step 202 in FIG. 22), the DVD SL 75 is focused on, and the disc is tracked on (in step 220 in FIG. 22), thereby reproducing the single layer DVD images (in step 226 in FIG. 22).

In addition, although not described in connection with the conventional DVD player, (BP33) of the PFI in the Control Data Zone can be checked to recognize that the disc is a Twin format disc even when the DVD is first played back.

Next, when the user again specifies the playback of the dual layer HD DVD by use of the input terminal 190, the blue-violet laser is turned on by a signal 262 to switch to the HD DVD playback (in step 231 in FIG. 22), such that the dual layer HD DVD images can be reproduced in a manner previously shown (in step 256 in FIG. 22).

As described above, according to the present invention, the HD DVD and the dual layer DVD can be formed in one optical disc. In the existing DVD apparatus, the dual layer DVD layer is played back. In the HD DVD apparatus compatible with the HD DVD standard, the HD DVD layer is played back. In the compatible apparatus according to the present invention, both the DVD layer and the HD DVD layer can be played back. It is thus possible to allow compatibility between a group of products of the existing DVD standard and a group of products of the new HD DVD standard, and also to accelerate a smooth spread of the HD DVD standard product group to general users.

### Other Embodiments

In the embodiment described above, the translucent films of the first recording layer and the second recording layer are formed of an Ag alloy. However, if reflectivity and transmissivity can be selectively set for each of the two laser beams different in wavelength, the apparatus can be more efficiently operated.

For example, the first recording layer and the second recording layer can be formed of multiple interference films to set a more effective reflectivity.

Furthermore, all the recording layers described are playback-only (ROM) recording layers in the present invention, but the combination of the recording layers is not limited thereto. For example, the third recording layer may be a recordable type. In that case, the reflectivity of the third recording layer is reduced to less than half of that in the case of the ROM.

<Summary of Basic Points in the Embodiment Described Above>

An optical disc according to the present invention is basically specified by the following items (1) to (7).

(1) The optical disc is a single-sided triple layer optical disc where a light transmission layer, a first recording layer which is accessed with a first laser beam, and a second recording layer and a third recording layer which are accessed with a second laser beam are arranged in this order in a direction in which the laser beams enter.

(2) The first recording layer is positioned a minimum of 550 μm from a light incidence plane.

(3) The distance between the first recording layer and the third recording layer is a maximum of 72 μm.

(4) The distance between the second recording layer and the third recording layer is a minimum of 19 μm.

(5) The distance between the first recording layer and the second recording layer is about 28 to 38 μm.

(6) The reflectivity of the first recording layer with respect to the first laser beam is 45% or more.

(7) The areal recording density of the second recording layer and the third recording layer is three times or more as high as the areal recording density of the first recording layer.

Furthermore, the optical disc according to the present invention can additionally implement the following items (8) to (10) on the basis of the above items:

(8) The reflectivity of the second recording layer with respect to the first laser beam is below 8%.

(9) The reflectivities of the second recording layer and the third recording layer with respect to the second laser beam are 7 to 12%.

(10) The ratio between the reflectivities of the second recording layer and the third recording layer is about ±10% or less.

An optical disc apparatus according to the present invention is specified by the following items (11) to (19):

(11) The optical disc apparatus is an apparatus which reads information recorded on an optical disc.

(12) The optical disc is a single-sided triple layer optical disc where a light transmission layer, a first recording layer which is accessed with a first laser beam, and a second recording layer and a third recording layer which are accessed with a second laser beam are arranged in this order in a direction in which the laser beams enter.

(13) The first recording layer is positioned a minimum of 550 μm from a light incidence plane.

(14) The distance between the first recording layer and the third recording layer is a maximum of 72 μm.

(15) The distance between the second recording layer and the third recording layer is a minimum of 19 μm.

(16) The distance between the first recording layer and the second recording layer is about 28 to 38 μm.

(17) The reflectivity of the first recording layer with respect to the first laser beam is 45% or more.

(18) The areal recording density of the second recording layer and the third recording layer is three times or more as high as the areal recording density of the first recording layer.

(19) The information reading apparatus comprises an optical head which can generate the first laser beam and the second laser beam, and control means for causing the first laser beam or the second laser beam to be selectively generated.

Furthermore, the optical disc apparatus according to the present invention can additionally implement the following items (20) to (22) on the basis of the above items:

(20) The reflectivity of the second recording layer with respect to the first laser beam is below 8%.

(21) The reflectivities of the second recording layer and the third recording layer with respect to the second laser beam are 7 to 12%.

(22) The ratio between the reflectivities of the second recording layer and the third recording layer is about ±10% or less.

Furthermore, the optical disc apparatus according to the present invention can additionally implement the following item (23) on the basis of the above items:

(23) When the optical disc is loaded, the second laser beam is first turned on to access the second recording layer and the third recording layer.

Furthermore, the optical disc apparatus according to the present invention can additionally implement the following item (24) on the basis of the above items:

(24) The control means selects the first laser beam or the second laser beam in accordance with a user input from a user interface.

It is to be noted that the present invention is not limited to the embodiment described above without modification. For example, some of all the components shown in the embodiment may be eliminated. Moreover, components in different embodiments may be suitably combined.

According to the embodiment described above, it is possible to provide an optical disc which enables a first recording layer to be accessed with a first laser beam (red laser beam) and enables a second recording layer and a third recording layer (corresponding to HD DVD layers) to be accessed with a second laser beam (blue-violet laser beam) from one side. Therefore, a single optical disc can contain both movie content for the currently widespread DVD, and movie content for the dual layer HD DVD. As a result, this disc can serve as a single layer DVD to supply content of movies or the like recorded therein and also as a dual layer HD DVD to supply contents of HD images including bonus content, such that the disc is a real combination disc which can deal with both standard definition (SD) images and high definition (HD) images.

Furthermore, DVD content can be reproduced in conventional DVD compatible optical disc apparatus. On the other hand, the new HD DVD compatible optical disc apparatus can be adapted to be able to reproduce the movie content for the HD DVD or to reproduce both the movie content for the HD DVD and the movie content for the DVD.

For example, identical movie content is prepared as DVD content and HD DVD content, and if these two kinds of movie content are recorded on a single disc, a user who has a DVD compatible apparatus alone can see the DVD movie content, while a user who has an HD DVD compatible apparatus can see the HD DVD movie content.

If the user who does not presently have an HD DVD compatible apparatus purchases an HD DVD compatible apparatus in the future, he/she can enjoy the HD images with an already purchased optical disc without newly purchasing an HD DVD disc, which is a great advantage to the user.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A single-sided triple layer optical disc comprising: a light transmission layer; a first recording layer which is accessed with a first laser beam; and a second recording layer and a third recording layer which are accessed with a second laser beam, these layers being arranged in this order in a direction in which the laser beams enter, wherein
the first recording layer is positioned a minimum of 550 μm from a light incidence plane,
the distance between the first recording layer and the third recording layer is a maximum of 72 μm,
the distance between the second recording layer and the third recording layer is a minimum of 19 μm,
the distance between the first recording layer and the second recording layer is about 28 to 38 μm,
the reflectivity of the first recording layer with respect to the first laser beam is 45% or more, and
the areal recording density of the second recording layer and the third recording layer is three times or more the areal recording density of the first recording layer.

2. The optical disc according to claim 1, wherein the reflectivity of the second recording layer with respect to the first laser beam is below 8%, the reflectivities of the second recording layer and the third recording layer with respect to the second laser beam are 7 to 12%, and the ratio between the reflectivities of the second recording layer and the third recording layer is about ±10% or less.

3. A manufacturing method of an optical disc comprising: preparing a first signal substrate where a first recording layer is formed; forming a second recording layer, via a second space layer, on a third recording layer formed on a second signal substrate; and bonding the first signal substrate and the second signal substrate in such a manner that the recording layer surfaces of the two substrates lie between these substrates, thereby forming a first space layer, wherein
the first recording layer is positioned a minimum of 550 μm from a light incidence plane of the first recording layer,
the distance between the first recording layer and the third recording layer is a maximum of 72 μm,
the distance between the second recording layer and the third recording layer is a minimum of 19 μm,
the distance between the first recording layer and the second recording layer is about 28 to 38 μm,
the reflectivity of the first recording layer with respect to the first laser beam is 45% or more, and
the areal recording density of the second recording layer and the third recording layer is three times or more the areal recording density of the first recording layer.

4. An optical disc apparatus which reads information recorded on an optical disc,
the optical disc being a single-sided triple layer optical disc comprising: a light transmission layer; a first recording layer which is accessed with a first laser beam; and a second recording layer and a third recording layer which are accessed with a second laser beam, these layers being arranged in this order in a direction in which the laser beams enter, wherein
the first recording layer is positioned a minimum of 550 μm from a light incidence plane,
the distance between the first recording layer and the third recording layer is a maximum of 72 μm,
the distance between the second recording layer and the third recording layer is a minimum of 19 μm,
the distance between the first recording layer and the second recording layer is about 28 to 38 μm,
the reflectivity of the first recording layer with respect to the first laser beam is 45% or more, and
the areal recording density of the second recording layer and the third recording layer is three times or more the areal recording density of the first recording layer,
the information reading apparatus comprising:
an optical head which is configured to generate the first laser beam and the second laser beam; and
control means for causing the first laser beam or the second laser beam to be selectively generated.

5. The optical disc apparatus according to claim 4, wherein
the control means selects the first laser beam or the second laser beam in accordance with a user input by a user interface.
